(19) United States
(12) Patent Application Publication
(10) Pub. No.: US 2026/0161705 A1
(43) Pub. Date: Jun. 11, 2026

(54) LYRIC TRANSCRIPTION SYSTEMS, DEVICES, AND METHODS

(71) Applicant: MOISES SYSTEMS, INC., Salt Lake City, UT (US)

(72) Inventors: Hugo Rodrigues, Salt Lake City, UT (US); Geraldo Ramos, Salt Lake City, UT (US)

(21) Appl. No.: 19/409,448

(22) Filed: Dec. 4, 2025

Related U.S. Application Data
(60) Provisional application No. 63/728,911, filed on Dec. 6, 2024.

(51) Int. Cl. G06F 16/683; G06F 16/68

(52) U.S. Cl. CPC G06F 16/685; G06F 16/686

(57) ABSTRACT

A system is configured to facilitate lyric acquisition for audio content. The system accesses audio content and generates an AI-based lyric transcription that includes lyric segments comprising words. A user interface presents the lyric transcription in editable form to enable user modification and validation of words and segment boundaries. After user validation, the system generates an AI-based temporally aligned lyric transcription by determining a timestamp for each validated lyric segment based on the audio content. The temporally aligned lyric transcription is presented in editable form to enable user modification of timestamps and lyric text. The system receives user confirmation of finalized lyric segments and corresponding finalized timestamps. The system may construct a lyric transcription package comprising the finalized temporally aligned lyric transcription, a language designation, a track title, and an artist name, and may submit the package to distribution platforms.

### CROSS-REFERENCE TO RELATED APPLICATIONS

This application claims priority to and the benefit of U.S. Provisional Patent Application No. 63/728,911, filed on Dec. 6, 2024, and entitled “LYRIC TRANSCRIPTION SYSTEMS, DEVICES, AND METHODS”, the entirety of which is incorporated herein by references for all purposes.

### BACKGROUND

Lyric transcription involves converting sung or spoken lyrics of audio into written text. Traditionally, lyric transcription is performed manually by individuals who listen to the audio and write down the words. However, advancements in artificial intelligence (AI) have enabled automated systems to perform this task using machine learning models trained on audio datasets containing lyrics and corresponding text. Lyric transcription is performed for various purposes, including generating subtitles for music videos, enabling search and recommendation systems in music streaming platforms, enhancing accessibility for hearing impaired individuals, supporting musicological research, legal compliance with copyright, royalty tracking, educational purposes (e.g., for language learners) and/or other purposes.

The subject matter claimed herein is not limited to embodiments that operate only in environments such as those described above. Rather, this background is only provided to illustrate one exemplary technology area where some embodiments described herein may be practiced.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a user interface frontend presenting audio content for which lyric acquisition may be performed.

FIG. 2 illustrates a user interface frontend presenting controls for customizing features of a lyric acquisition application.

FIGS. 3 and 4 illustrates a user interface frontend presenting lyric segments in editable form.

FIG. 5 illustrates a user interface frontend presenting validated lyric segments and associated timestamps in editable form.

FIG. 6 illustrates a conceptual representation of audio processing modules for determining lyric segments for presentation on a user interface frontend.

FIG. 7 illustrates a conceptual representation of audio processing modules for determining timestamps associated with validated lyric segments.

FIG. 8 illustrates a user interface frontend presenting controls for customizing features of a lyric acquisition application.

FIGS. 9 and 10 illustrate a user interface frontend presenting lyric segments and associated timestamps in editable form.

FIG. 11 depicts example components of a system that may comprise or be configurable to perform various embodiments.

### DETAILED DESCRIPTION

Disclosed embodiments are directed to systems and devices for facilitating lyric transcription.

As noted above, lyric transcription is performed in various domains for various purposes. AI techniques have facilitated various enhancements in lyric transcription processes. However, AI-based lyric transcription techniques face various challenges, particularly for music artists relying on lyric service providers or distributors. For instance, AI systems often struggle with understanding non-standard pronunciations, slang, and/or artistic variations in vocal delivery, which can give rise to inaccuracies in AI lyric transcription output. Accuracy issues can be prevalent in certain genres, such as rap or experimental music, where lyrics may deviate from conventional grammar or use heavily stylized phrasing. Background music, overlapping vocals, and/or other sound effects can further contribute to inaccuracies in AI-based transcription processes, leading to incomplete or incorrect lyrics.

Artists also often face a lack of transparency and/or control with AI-based lyric transcription services. Lyric transcription service providers and/or tools often fail to offer a clear process for reviewing and/or correcting automated transcriptions before publication, which can lead to mistranscriptions being disseminated widely. Mistranscriptions can affect fan engagement, search engine visibility, synchronization with other media (e.g., karaoke or music video platforms), and/or other aspects of music distribution.

Disclosed embodiments are directed to systems and methods for facilitating lyric acquisition, whereby a user interface frontend is presented on a display and is configured to receive user input for triggering generation of AI-based lyric transcription output. The AI-based lyric transcription output can include lyric segments determined for a piece of audio content (e.g., a music file), with each lyric segment including one or more words. The lyric segments can be divided/separated in various ways, such as via line breaks (where each separate line represents a different lyric segment), and the lyric segments may be editable by users via the user interface frontend (e.g., allowing users to modify the words, change the division/separation of the lyric segments, etc.). After receiving additional user input validating/confirming the lyric segments at the user interface frontend (e.g., after any user modifications to the lyric segments), a system may trigger generation of additional AI-based lyric transcription output. The additional AI-based lyric transcription output may indicate temporal alignment of the validated/confirmed lyric segments with the piece of audio content from which the lyric segments were derived. For example, each of the validated/confirmed lyric segments may be presented in association with one or more timestamps indicating the timepoint(s) in the temporal progression of the audio content at which one or more words of each lyric segment is/are uttered. The timestamps and the validated/confirmed lyric segments may be presented on the user interface frontend, enabling users to edit the timestamps and/or lyric segments. The user may finalize the lyric segments and timestamps by providing further user input, thereby indicating a finalized temporally aligned lyric transcription. The finalized temporally aligned lyric transcription may be used to construct a lyric transcription package for use by one or more distribution platforms. The lyric transcription package can include, for instance, the finalized temporally aligned lyric transcription, a language associated therewith, a track title, an artist name, and/or other information.

In some embodiments that provide a streamlined lyric acquisition approach, the initial step of presenting initially determined lyric segments for user modification (e.g., without corresponding timestamps) is omitted.

Disclosed embodiments can facilitate various improvements for lyric acquisition processes, methods, and/or services. For instance, presenting initial AI-determined lyric segments for user modification and confirmation and then subsequently determining temporal alignment of the confirmed lyric segments with the underlying audio content can mitigate errors in lyric segment division and temporal alignment for the final transcription output. Furthermore, processes described herein are user-interactive and incremental (e.g., enabling users to intervene at various steps throughout the inference/prediction process), which can facilitate detection and/or correction of AI transcription errors and can facilitate further training and/or fine-tuning of transcription and/or temporal alignment models. In some embodiments, lyric segments and/or timestamps are presented simultaneously with a playback feature for the underlying audio content within the user interface frontend, which can facilitate rapid and convenient validation of AI output for users. Additional features and benefits achieved by implementing the disclosed principles will be described in more detail hereinafter.

Having just described some of the various high-level features and benefits of the disclosed embodiments, attention will now be directed to the Figures, which illustrate various conceptual representations, architectures, methods, and/or supporting illustrations related to the disclosed embodiments.

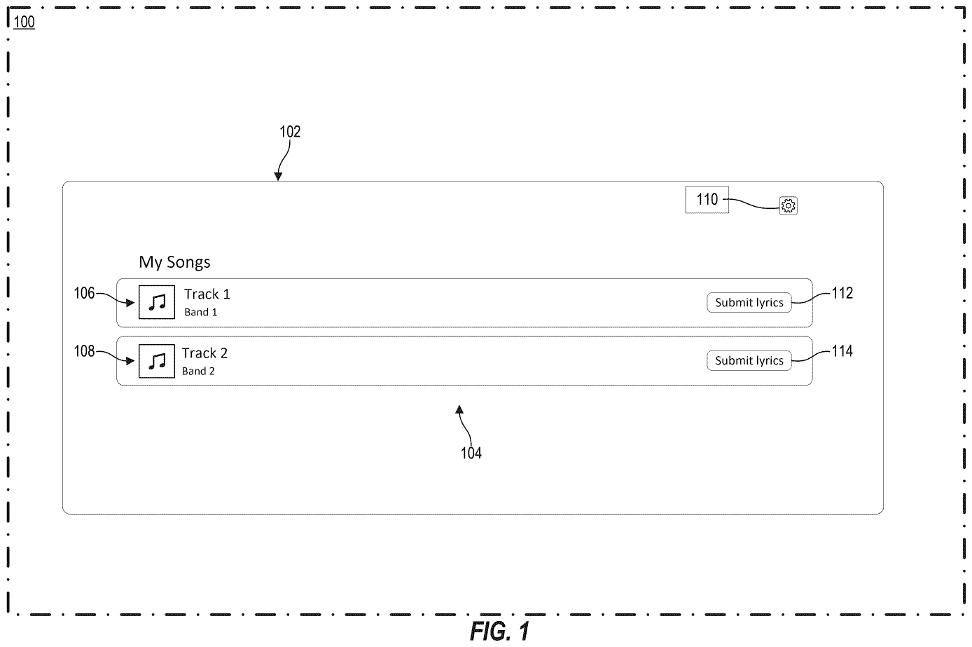

FIG. 1 illustrates conceptual representation of a user interface frontend 100 that presents an audio content selection interface 102. The user interface frontend 100 can include various sections, interfaces, pages, or components that can present information to users (e.g., visually or otherwise) and/or provide a framework or structure for facilitating user interaction such as by receiving user input (e.g., providing user input fields, selectable elements/controls/buttons, etc.). The user interface frontend 100 can comprise one or more aspects of a software program or application (e.g., a locally stored and/or web-based program or application) that is executable using one or more components of a system 1100 and/or remote system 1112 (e.g., server). For example, the user interface frontend 100 may be presented on user devices in association with computer software or program offerings of a lyric service provider or music distributor, allowing music artists or others to engage with a lyric acquisition workflow facilitated via the user interface frontend 100.

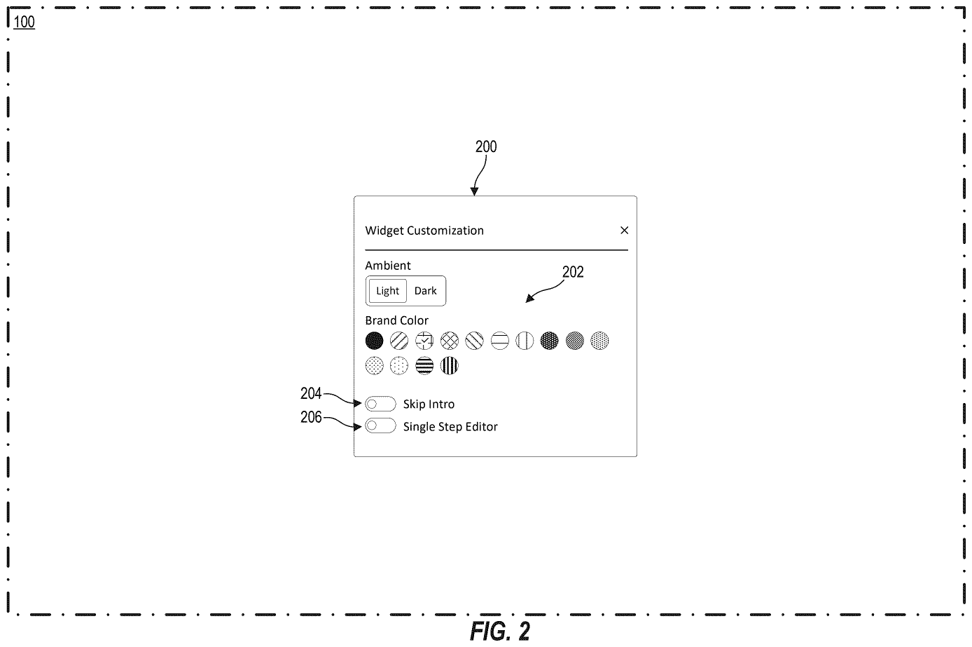

In some instances, controls for instantiating or executing the user interface frontend 100 are integrated with other user interface frontends (e.g., where the user interface frontend 100 comprises a widget or plugin for integration with other software, websites, etc.). In some implementations, one or more aspects or features of the user interface frontend 100 are customizable by end users. For instance, the user interface frontend 100 is shown in FIG. 1 as including a customization control 110, which may be selectable to cause presentation of a customization interface 200 shown in FIG. 2, which may be presented as part of or in association with the user interface frontend 100. In the example shown in FIG. 2, the customization interface 200 includes controls 202 for modifying visual characteristics of the user interface frontend 100 (e.g., controlling light or dark ambience, or controlling brand color). The customization interface 200 shown in FIG. 2 further includes a control 204 for configuring whether the user interface frontend 100 skips an introduction interface associated with a lyric acquisition workflow. The customization interface 200 shown in FIG. 2 further includes a control 206 for configuring whether the user interface frontend 100 facilitates a streamlined lyric acquisition workflow (e.g., controlled by whether the “Single step editor” toggle switch is set to on or off). In the examples shown and described with reference to FIGS. 1-7, the streamlined lyric acquisition workflow is disabled (i.e., control 206 is set to off).

Referring again to FIG. 1, the example audio content selection interface 102 provides a list 104 of items of audio content 106 and 108 for which lyric acquisition may be performed. The items of audio content 106 and 108 comprise one or more locally and/or remotely stored audio or recording files. The audio content can include data/information allowing for playback of associated audio when used in conjunction with a playback device. In some implementations, audio content may be added to the list 104 displayed on the user interface frontend 100 via one or more user actions. For example, the user interface frontend 100 can include a record and/or an add button or feature, which may be selectable via user input to facilitate addition of items of audio content to the list 104 (e.g., from a local or remote repository).

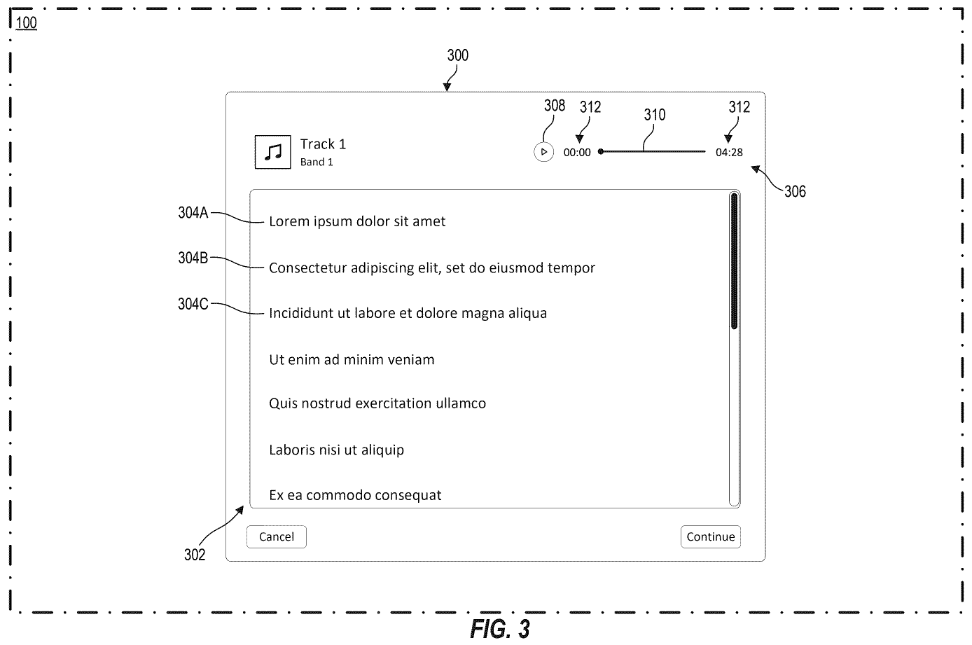

The audio content selection interface 102 shown in FIG. 1 includes controls 112 and 114 for initiating (or continuing) a lyric acquisition workflow for the items of audio content 106 and 108, respectively. FIG. 3 illustrates an example lyric segment interface 300, which may be presented as part of or in association with the user interface frontend 100. In the example shown in FIG. 3, the lyric segment interface 300 is presented on the user interface frontend 100 after selection of control 112 (associated with audio content 106). The example lyric segment interface 300 includes an AI-generated lyric transcription 302 that includes lyric segments 304A, 304B, and 304C (and others). Each of the lyric segments 304A, 304B, and 304C is represented in the lyric segment interface 300 as lines of text, with each including one or more words, and with line breaks indicating divisions between the lyric segments 304A, 304B, and 304C.

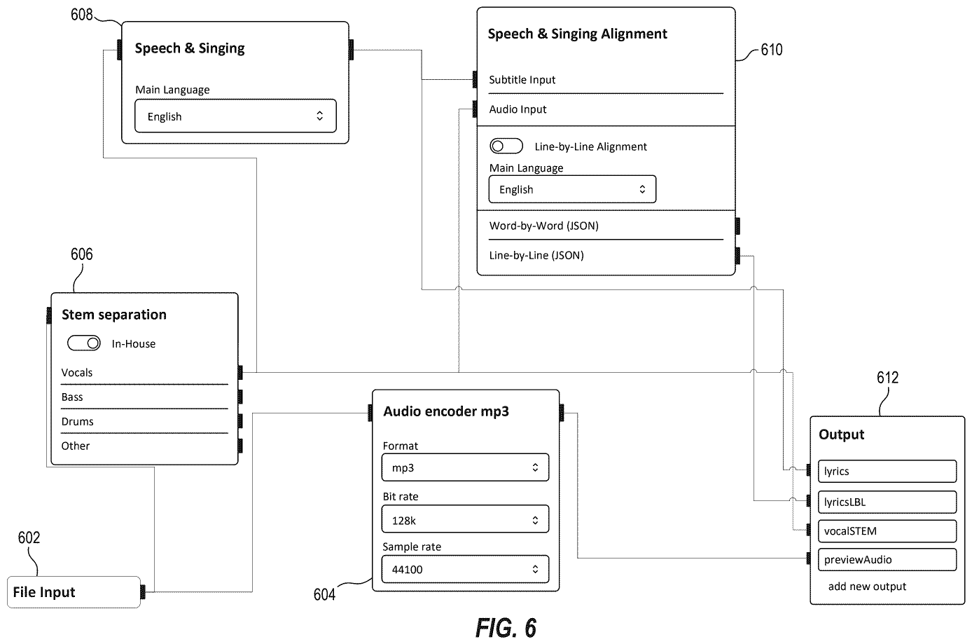

The AI-generated lyric transcription 302 may be generated based on the audio content 106 selected for lyric acquisition. In some implementations, the AI-generated lyric transcription 302 is pre-generated (e.g., prior to selection of control 112) and is accessed for presentation on the user interface frontend 100 after selection of control 112. For instance, a batch of items of audio content may be pre-processed to generate AI-generated lyric transcriptions for each of the items of audio content (e.g., during downtime or otherwise in advance), and the AI-generated lyric transcriptions may be readily accessed for lyric acquisition workflows via the user interface frontend 100. In some implementations, the AI-generated lyric transcription 302 is generated after or in response to selection of control 112. Additional details concerning the generation of the AI-generated lyric transcription 302 will be provided hereinbelow with reference to FIG. 6.

The example lyric segment interface 300 shown in FIG. 3 presents the AI-generated lyric transcription 302 in editable form. For instance, a user may provide user input directed to the user interface frontend 100 to modify the lyric segments 304A, 304B, 304C, etc. thereof. In one example, the AI-generated lyric transcription 302 is presented as editable text, allowing users to modify the words of the lyric segments (e.g., changing, adding, or removing words) and/or combine or separate lyric segments (e.g., by changing the line or paragraph breaks dividing the lyric segments).

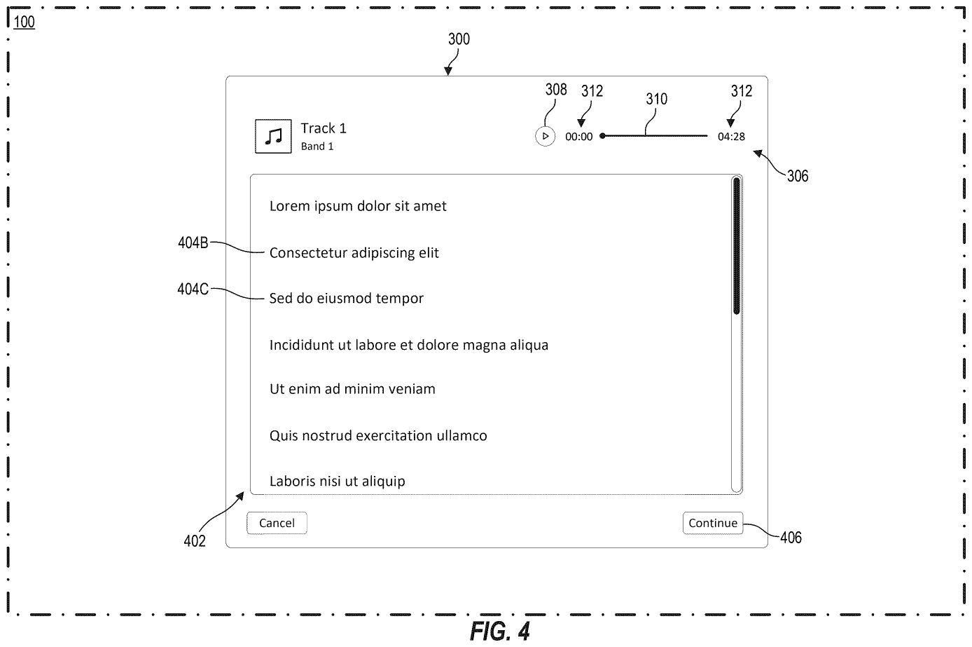

FIG. 4 illustrates the lyric segment interface 300 after user input has been directed to the user interface frontend 100 to modify the AI-generated lyric transcription 302. In the example shown in FIG. 4, the lyric segment interface 300 presents a modified lyric transcription 402, which reflects user-driven modifications to lyric segment 304B of the AI-generated lyric transcription 302 shown in FIG. 3. For instance, in modified lyric transcription 402, lyric segment 304B from the AI-generated lyric transcription 302 is divided into two lyric segments 404B and 404C, and the word “set” from lyric segment 304B has been changed to “sed” in lyric segment 404C.

In the example shown in FIG. 4, the lyric segment interface 300 includes a control 406 that is interactable by users to confirm that the modified lyric transcription 402 includes accurate divisions of the lyric segments (e.g., accurate line or paragraph breaks) and that each of the lyric segments includes accurate words (according to the user). In some implementations, selection of the control 406 causes the modified lyric transcription 402 as presented on the lyric segment interface 300 to be defined as a validated lyric transcription, which includes validated lyric segments and validated words (e.g., indicated by the user to be correct). When no modifications are made to the AI-generated lyric transcription 302, selection of the control 406 may cause the AI-generated lyric transcription 302 to be defined as the validated lyric transcription. Formats for receiving user input to confirm the validated lyric transcription other than controls displayed on the user interface frontend 100 are within the scope of the present disclosure (e.g., keystroke, tap, gesture, voice, and/or others).

In the example shown in FIGS. 3 and 4, the AI-generated lyric transcription 302 (and the modified lyric transcription 402) is presented on the user interface frontend 100 with a playback feature 306, which can be interactable by the user to facilitate playback of the item of audio content 106 (or a vocals stem obtained therefrom) used to generate the AI-generated lyric transcription 302 (or the modified lyric transcription 402). Enabling playback of the item of audio content 106 (or a vocals stem obtained therefrom) in conjunction with presenting the AI-generated lyric transcription 302 can assist users in accurately modifying/validating the AI-generated lyric transcription 302 by providing them with a source of ground truth to define the validated lyric transcription. The playback feature 306 can include various elements, such as a play/pause element 308, a playback navigation bar 310 (e.g., for indicating playback progress and/or facilitating scrubbing/navigating through the audio content), time indicators 312 (e.g., indicating current playback time and total playback duration), navigation controls (e.g., for navigating or skipping forward or backward in time by predetermined intervals, such as 5 seconds, 10 seconds, etc.), and/or others.

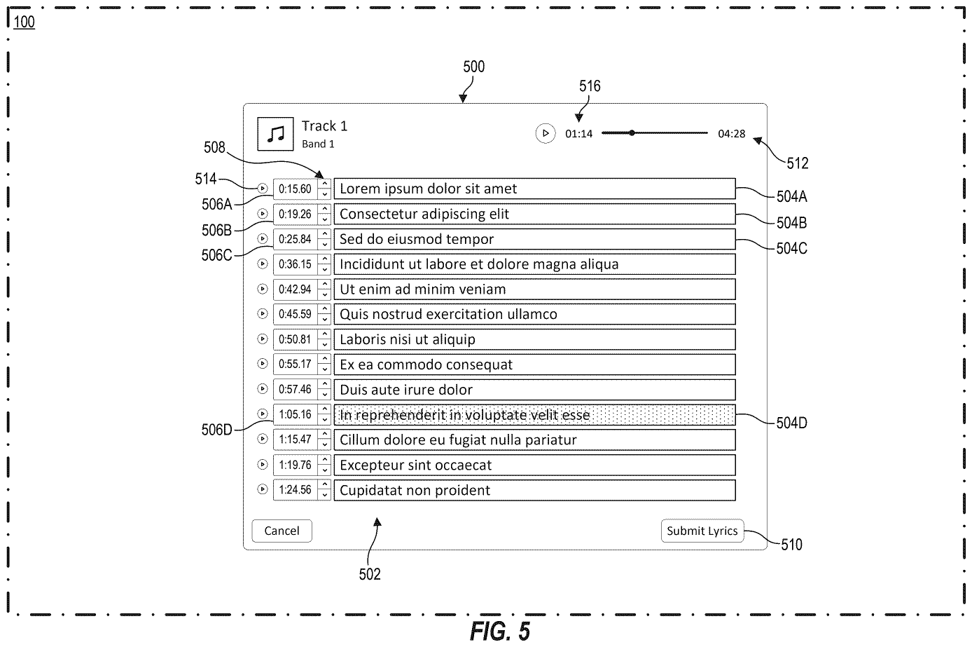

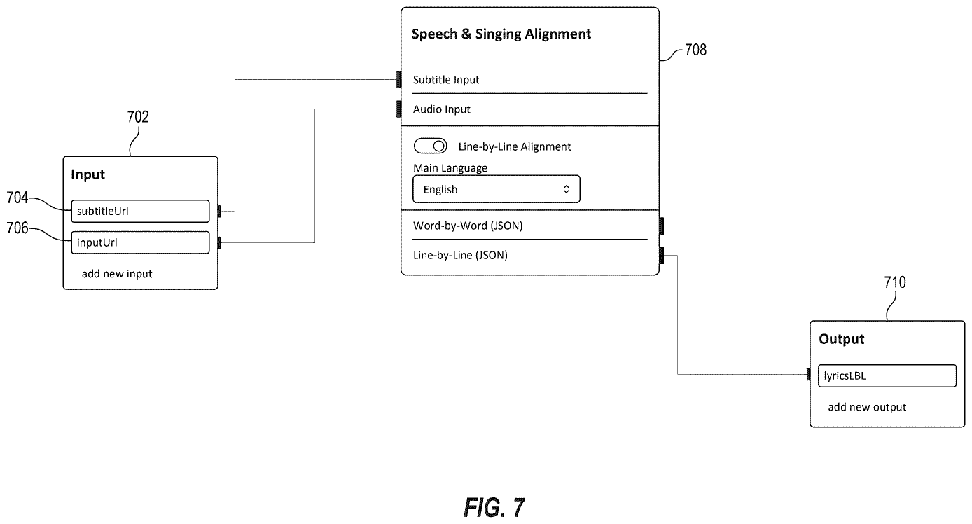

The validated lyric transcription (e.g., defined after user selection of control 406) may be used to generate an AI-generated temporally aligned lyric transcription. Additional details related to generating the AI-generated temporally aligned lyric transcription will be provided hereinbelow with reference to FIG. 7. FIG. 5 illustrates a lyric alignment interface 500 that presents a temporally aligned lyric transcription 502, which may comprise an AI-generated temporally aligned lyric transcription generated based on the modified lyric transcription 402 (or the validated lyric transcription) discussed above. In the example shown in FIG. 5, the temporally aligned lyric transcription 502 includes validated lyric segments 504A, 504B, and 504C (and others) as well as respective timestamps 506A, 506B, and 506C (and others) for each of the validated lyric segments. In the example shown in FIG. 5, the timestamps 506A, 506B, and 506C (and others) indicate the timepoint in the temporal progression of the audio content 106 at which its associated lyric segment begins (though other frameworks are possible, such as where the timestamps indicate the end of an associated lyric segment, or where multiple timestamps are presented for each lyric segment indicating the temporal beginning, end, middle, etc. of each lyric segment and/or one or more words of each lyric segment).

The example lyric alignment interface 500 shown in FIG. 5 presents the temporally aligned lyric transcription 502 in editable form. For instance, a user may provide user input directed to the user interface frontend 100 to modify the timestamps 506A, 506B, 506C (or others). For example, the timestamps 506A, 506B, 506C (or others) may be presented as editable text, permitting users to modify or replace the text defining the various timestamps for the validated lyric segments 504A, 504B, 504C (or others). As another example, as shown in FIG. 5, the timestamps 506A, 506B, 506C (or others) may additionally or alternatively be presented with controls 508 for modifying the timestamps (e.g., to increase or decrease the timestamp values by a predefined interval). In some implementations, the lyric alignment interface 500 permits users to provide user input to modify to the text characters and/or division (e.g., defined by line or paragraph breaks) of the validated lyric segments 504A, 504B, 504C (or others) (e.g., similar to the lyric segment interface 300 described above).

In the example shown in FIG. 5, the lyric alignment interface 500 includes a control 510 that is interactable by users to confirm that the temporally aligned lyric transcription 502 shown in the lyric alignment interface 500 includes timestamps 506A, 506B, 506C (and others) that accurately reflect the temporal occurrence their corresponding lyric segments (or words) within the audio content 106. The temporally aligned lyric transcription 502 may comprise the AI-generated temporally aligned lyric transcription when no user modifications are made to the timestamps 506A, 506B, 506C (and others) or the validated lyric segments 504A, 504B, 504C (and others), or the temporally aligned lyric transcription 502 may reflect user modifications made to the timestamps 506A, 506B, 506C (or others) or the validated lyric segments 504A, 504B, 504C (or others). In some implementations, selection of the control 510 causes the temporally aligned lyric transcription 502 as presented on the lyric alignment interface 500 to be defined as a finalized temporally aligned lyric transcription, which includes finalized timestamps associated with finalized lyric segments (with each finalized lyric segment including finalized words). Formats for receiving user input to confirm the finalized temporally aligned lyric transcription other than controls displayed on the user interface frontend 100 are within the scope of the present disclosure (e.g., keystroke, tap, gesture, voice, and/or others).

Similar to the AI-generated lyric transcription 302 and the modified lyric transcription 402 described above, the temporally aligned lyric transcription 502 may be presented on the user interface frontend 100 with a playback feature 512 for facilitating playback of the audio content 106 (or a vocals stem obtained therefrom), which can assist users in determining the correct timestamps for the various validated lyric segments 504A, 504B, 504C (and others). In some embodiments, the lyric alignment interface 500 may include controls for initiating playback of the audio content 106 (or a vocals stem obtained therefrom) at the various timepoints presented at the lyric alignment interface 500. For instance, in the example shown in FIG. 5, each of the timestamps 506A, 506B, 506C (and others) is presented in conjunction with a respective playback control 514, the selection of which may trigger playback of the audio content 106 (or a vocals stem obtained therefrom) at the timepoint indicated by the associated timestamp. Such functionality can assist users in temporally aligning each of the lyric segments with the underlying audio content 106. Other forms of user input for triggering playback of audio content at the defined timestamps may be used (e.g., treating the user interface elements defining the timestamps or the lyric segments or words as selectable controls for triggering playback).

In some instances, during playback of the audio content 106 (or a vocals stem obtained therefrom) the user interface frontend 100 can be configured to visually emphasize the lyric segment that temporally corresponds to the current playback timepoint of the audio content 106. In the example shown in FIG. 5, the current playback timepoint of the audio content 106 is 1:14 (indicated by time indicator 516), which temporally aligns with validated lyric segment 504D (which is indicated as beginning at the time 1:05.16 according to timestamp 506D). Accordingly, in the lyric alignment interface 500 shown in FIG. 5, lyric segment 504D is visually emphasized (e.g., via a pattern fill), which can readily communicate to users the lyric segment that temporally corresponds to the current playback time of the audio content 106. Such functionality can additionally assist users in temporally aligning each of the lyric segments with the underlying audio content 106.

After defining the finalized temporally aligned lyric transcription via the user interface frontend 100, a system (e.g., system 1100, remote system 1112) may construct a lyric transcription package, which may include the finalized temporally aligned lyric transcription, a language for the audio content 106, a track title, an artist name, and/or other information. The system may then submit the lyric transcription package to one or more distribution platforms (e.g., music distribution platforms).

FIG. 6 illustrates a conceptual representation of example audio processing modules for determining the AI-generated lyric transcription 302 described above for presentation on the user interface frontend 100. For instance, FIG. 6 illustrates an input module 602, which may designate and/or access the input audio content for lyric acquisition processing (e.g., audio content 106, or other audio content defined in an audio content selection interface 102).

FIG. 6 illustrates the input module 602 as being connected to an audio encoder module 604, indicating that the input audio content (e.g., audio content 106) may be used as input to the audio encoder module 604. The audio encoder module 604 can be configured to convert and encode an input audio signal to a different format, sample rate, and/or number of channels (e.g., supporting various common audio codecs and formats). FIG. 6 illustrates the audio encoder module 604 as including processing settings for defining the audio format for the audio output (e.g., MP3, M4A, WAV, AAC, FLAC, OGG, WMA, AIFF, ALAC, AMR, APE, AU, DCT, DSS, DVF, GSM, IKLAX, IVS, M4P, MMF, MPC, MSV, NMF, NSF, OPUS, RA, RM, RAW, RF64, SLN, TTA, VOX, VOC, W64, WEBM, WV, 8SVX, CDA, and/or others), the sample rate for the audio output to control the resolution and quality of the audio output (e.g., 11025 Hz, 16000 Hz, 22050 Hz, 44100 Hz, 48000 Hz, 96000 Hz), the number of audio channels for the output file (e.g., mono (1) or stereo (2)), etc. The audio encoder module 604 may enable the input audio content to be transformed/modified to correspond to specifications or requirements of one or more music distribution platforms. Advantageously, this encoding may be performed in conjunction with (e.g., in parallel or in series with) lyric acquisition processing as described herein.

FIG. 6 also illustrates the input module 602 as being connected to a stem separation module 606, indicating that the input audio content (e.g., audio content 106) may be used as input to the stem separation module 606. Stem separation refers to separating audio content into its basic components or “stems,” which correspond to types of sound represented in audio content such as vocals, drums, bass, strings, piano/keys, melody, dialogue, effects, background music, uncategorized sound, etc. The stem separation module 606 can utilize pattern recognition and spectral analysis to separate sound sources from the audio content based on audio characteristics such as frequency and amplitude. The stem separation module 606 may utilize AI techniques (e.g., CNNs, RNNs, FCNs, transformers, autoencoders, etc.), which may improve isolation of sound sources from audio content where different sound sources have overlapping frequencies.

In the example shown in FIG. 6, the stem separation module 606 is configured to isolate a vocals stem (labeled “Vocals”). The stem separation module 606 may be configured to isolate additional audio stems (e.g., bass, drums, other/remaining audio, and/or others). FIG. 6 illustrates the vocals stem connected to a transcription module 608. The transcription module 608 may utilize AI techniques (e.g., automatic speech recognition (ASR) models, language models (LMs), and/or others) and may be configured to transcribe sung or spoken utterances from input audio into textual form. In some implementations, the transcription module 608 includes processing settings for user selection of a language for utterance detection, or the language may be automatically detected (e.g., by the transcription module 608 or an upstream language detection module).

The output of the transcription module 608 may comprise a set of lyrics, which FIG. 6 conceptually depicts as being connected to an alignment module 610, indicating that the set of lyrics may be used as input to the alignment module 610. FIG. 6 additionally illustrates the stem separation module 606 as being connected to the alignment module 610, indicating that that the vocals stem output of the stem separation module 606 may be used as input to the alignment module 610. The alignment module 610 is configured to process input audio containing speech and/or singing (e.g., the vocals stem, or the input audio content itself from the input module 602) to temporally align the speech and/or singing with corresponding text (e.g., subtitle lines or words). The alignment module 610 may utilize AI techniques (e.g., ASR models, dynamic time warping, end-to-end alignment models, phoneme-level alignment models, and/or others) and may generate word-by-word and/or line-by-line aligned data (e.g., in JSON format, or another format). In some instances, the alignment module 610 includes processing settings for user selection of a language for the input audio content (e.g., the vocals segment) and/or the input set of lyrics, or the language may be automatically detected (e.g., by the alignment module 610 or an upstream language detection module).

The output of the alignment module 610 may comprise an AI-generated lyric transcription (e.g., the AI-generated lyric transcription 302 noted above), which may define or separate lyric segments from the set of lyrics input to the alignment module 610 (e.g., in a generic subtitle format). In some implementations, the output of the alignment module 610 may additionally include timestamps associated with the lyric segments. In the example shown in FIGS. 3 and 4, the timestamps output by the alignment module 610 are discarded or otherwise not presented on the user interface frontend 100 in association with the AI-generated lyric transcription 302 (e.g., indicated in FIG. 6 by the “Line-by-line Alignment” control of the alignment module 610 being set to an off state, indicating that the AI-generated lyric transcription output of the alignment module 610 will not be coupled with the line-by-line timestamps). Such functionality can allow users to initially focus on validating the words and division of the lyric segments (e.g., represented by line or paragraph breaks) from the AI-generated lyric transcription 302 (with temporal alignment being handled by the subsequent step(s) shown and described with reference to FIG. 5).

FIG. 6 conceptually depicts the line-by-line lyric output (e.g., the lyric segment output or the AI-generated lyric transcription output) of the alignment module 610 as being connected to an output module 612. The output module 612 can facilitate access to and/or provision of output data or information resulting from the lyric acquisition and/or other audio processing tasks performed by the other modules. The output module 612 may facilitate provision of the AI-generated lyric transcription 302 for presentation on the user interface frontend 100 as described above with reference to FIG. 3. In the example shown in FIG. 6, the output module 612 includes multiple channels for receiving various outputs from the other modules (indicated in FIG. 6 by connections between the various modules and the output module 612). For instance, the output module 612 further receives the set of lyrics output by the transcription module 608, the vocals stem output generated by the stem separation module 606, encoded audio output by the audio encoder module 604. These other outputs provided to the output module 612 may be used in various ways. For example, the vocals stem and/or the encoded audio output may be used for playback in conjunction with the playback features 306 and/or 512 as described above.

Although FIG. 6 focuses on examples in which a vocals stem is obtained via the stem separation module 606 and used as an input for performing lyric transcription via the transcription module 608, other configurations are possible, such as where transcription is performed directly on the input audio content (e.g., from the input module 602) and/or on the encoded audio output by the audio encoder module 604. One will appreciate that various steps and/or aspects of the module framework shown in FIG. 6 may be omitted or varied (e.g., audio encoding may be omitted, the output module 612 may not receive various other outputs described above, etc.).

FIG. 7 illustrates a conceptual representation of example audio processing modules for determining the temporally aligned lyric transcription 502 described above for presentation on the user interface frontend 100. For instance, FIG. 7 illustrates an input module 702 that indicates the inputs for generating the temporally aligned lyric transcription 502, including the validated lyric transcription (indicated at input channel 704) and the vocals stem (indicated at input channel 706). The validated lyric transcription may comprise the lyric transcription validated by a user via the lyric segment interface 300 at the user interface frontend 100 (e.g., by selection of control 406). Although channel 706 of the input module 702 shown in FIG. 7 designates the vocals stem, the underlying audio content (e.g., audio content 106) or the encoded audio output (e.g., output by audio encoder module 604) may be used.

FIG. 7 illustrates the input module 702 as being connected to an alignment module 708, with both the validated lyric transcription (from channel 704) and the vocals stem (from channel 706) being provided as inputs to the alignment module 708. The alignment module 708 is configured to determine timestamps for the validated lyric segments of the validated lyric transcription. In some implementations, the alignment module 708 comprises the same module as the alignment module 610 described above, but may operate with different settings. For example, the alignment module 708 may be configured to couple the lyric segment timestamps determined by the alignment module 708 with the line-by-line lyric segment output (e.g., indicated in FIG. 7 by the “Line-by-line Alignment” control of the alignment module 708 being set to an on state). The output of the alignment module 708 may comprise the AI-generated temporally aligned lyric transcription noted above (which may be presented as the temporally aligned lyric transcription 502 on the lyric alignment interface 500 within the user interface frontend 100) and/or one or more components thereof, such as lyric segments and/or associated timestamps for the lyric segments (and/or words thereof).

FIG. 7 conceptually depicts the line-by-line lyric output (e.g., the lyric segment, timestamp, and/or AI-generated temporally aligned lyric transcription output) of the alignment module 708 as being connected to an output module 710, which may facilitate access to and/or provision of the line-by-line lyric output. The output module 710 may facilitate provision of the AI-generated temporally aligned lyric transcription for presentation on the user interface frontend 100 as described hereinabove with reference to FIG. 5.

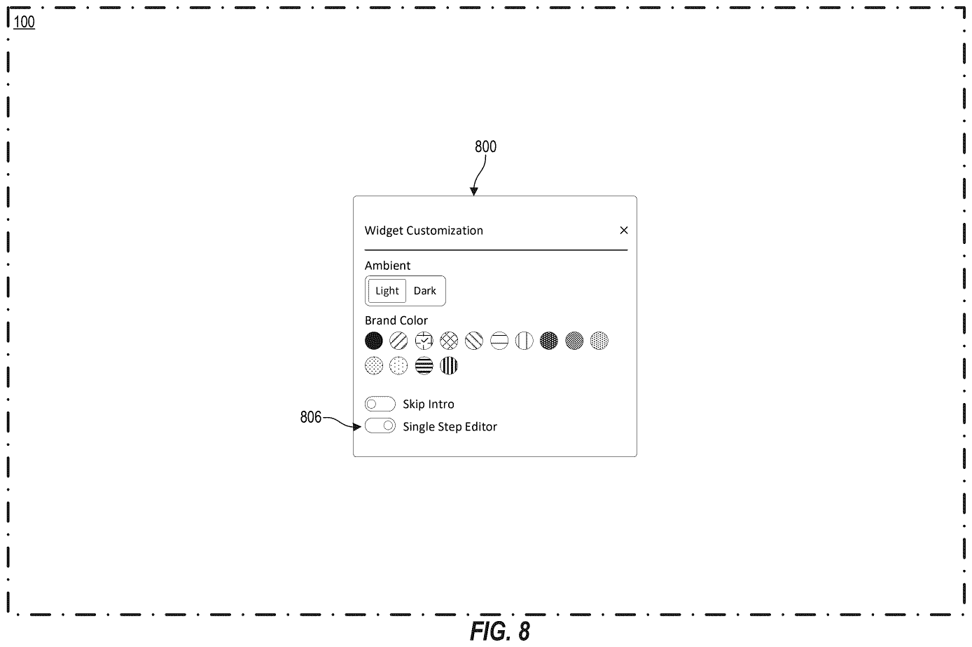

FIG. 8 illustrates a customization interface 800 corresponding to the customization interface 200 described hereinabove. In the customization interface 800, the control 806 for configuring whether the user interface frontend 100 facilitates a streamlined lyric acquisition workflow is set to an on state. In the examples shown and described with reference to FIGS. 8-10, the streamlined lyric acquisition workflow is enabled, which may, in some instances, allow for rapid lyric acquisition.

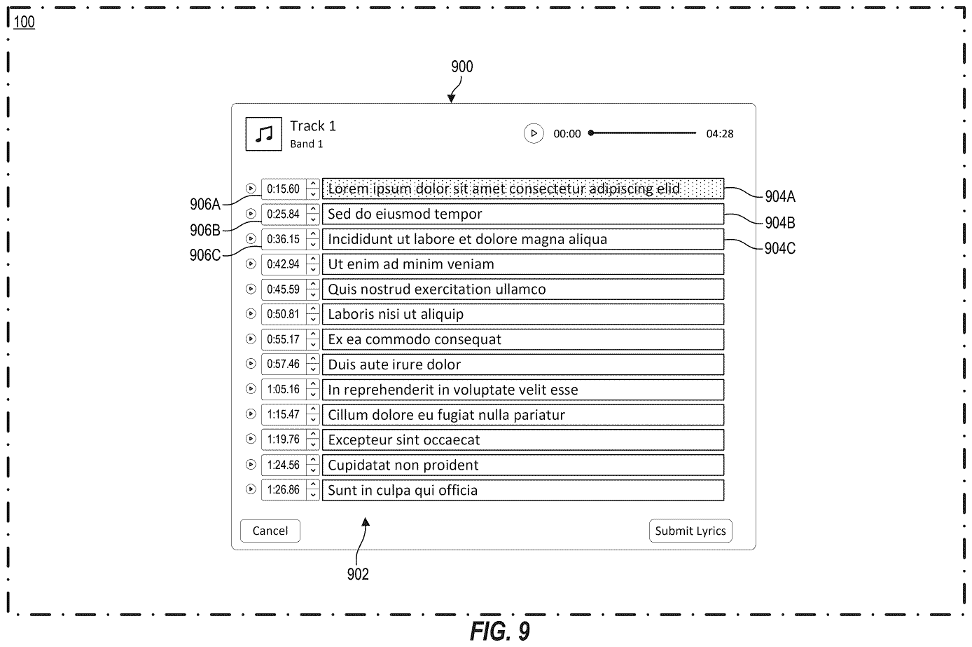

FIG. 9 illustrates the user interface frontend 100 presenting a lyric alignment interface 900 that is similar to the lyric alignment interface 500 described hereinabove with reference to FIG. 5. For instance, the lyric alignment interface 900 depicts an AI-generated temporally aligned lyric transcription 902 for the audio content 106 in editable form, allowing the user to provide user input directed to the user interface frontend 100 to modify the timestamps 906A, 906B, 906C (or others) for lyric segments 904A, 904B, 904C (or others). In contrast with the validated lyric segments 504A, 504B, 504C (and others) of the temporally aligned lyric transcription 502 shown and described with reference to FIG. 5, the lyric segments 904A, 904B, 904C (and others) of the AI-generated temporally aligned lyric transcription 902 of FIG. 9 are not validated lyric segments (e.g., there were not indicated as accurate by a human user prior to presentation on the lyric alignment interface 900). For instance, the AI-generated temporally aligned lyric transcription 902 may be generated using the modules shown and described with reference to FIG. 6, such as by providing the selected audio content (e.g., audio content 106) as input to the stem separation module 606 to obtain a vocals stem, processing the vocals stem with the transcription module 608 to obtain a set of lyrics, and processing the set of lyrics and the vocals stem with the alignment module 610 to obtain the AI-generated temporally aligned lyric transcription 902, including the lyric segments 904A, 904B, 904C (and others) and their corresponding timestamps 906A, 906B, 906C (and others) (e.g., to generate the AI-generated temporally aligned lyric transcription 902, the “Line-by-line Alignment” control of the alignment module 610 may be set to an on state to couple the lyric segment timestamps with the line-by-line lyric segment output). As noted above, although the vocals stem is used to determine the AI-generated temporally aligned lyric transcription 902 in this example, other audio signals may be used (e.g., the underlying audio content 106).

The AI-generated temporally aligned lyric transcription 902 may be accessed for presentation on the user interface frontend 100 after user input is received at the user interface frontend 100 for initiating or continuing a lyric acquisition workflow for the audio content 106 (e.g., by accessing a previously generated AI-generated temporally aligned lyric transcription 902 or by generating the AI-generated temporally aligned lyric transcription 902 after user input is directed to control 112). The lyric alignment interface 900 showing the AI-generated temporally aligned lyric transcription 902 may be presented on the user interface frontend 100 after presentation of the audio content selection interface 102 (e.g., without first presenting a lyric segment interface similar to lyric segment interface 300 for validation of the words and/or divisions of the lyric segments without corresponding timestamps).

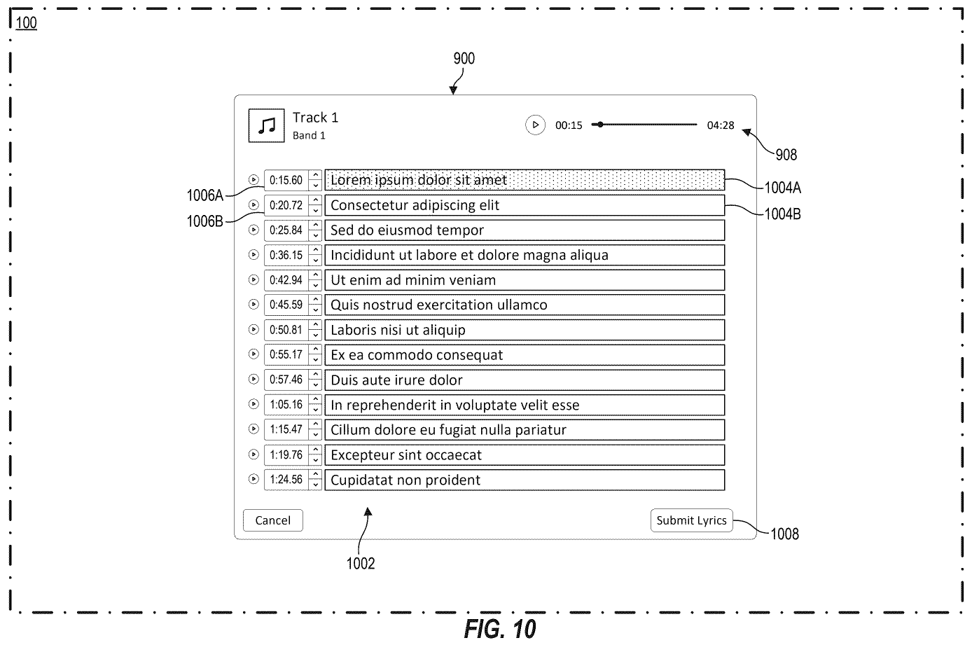

Similar to lyric alignment interface 500, the lyric alignment interface 900 may present the AI-generated temporally aligned lyric transcription 902 in editable form, allowing users to provide user input to modify the timestamps 906A, 906B, 906C (or others) and/or the text characters and/or divisions of the lyric segments 904A, 904B, 904C (or others). For example, FIG. 10 illustrates the lyric alignment interface 900 after user input has been directed to the 100 to modify the AI-generated temporally aligned lyric transcription 902. In the example shown in FIG. 10, the lyric alignment interface 900 presents a modified temporally aligned lyric transcription 1002, which reflects user-driven modifications to lyric segment 904A of the AI-generated temporally aligned lyric transcription 902 shown in FIG. 9. For instance, in the modified temporally aligned lyric transcription 1002, lyric segment 904A from the AI-generated temporally aligned lyric transcription 902 is divided into two modified lyric segments 1004A and 1004B, and the word “elid” from lyric segment 904A has been changed to “elit” in modified lyric segment 1004B. Similar to the lyric alignment interface 500, the lyric alignment interface 900 may present the AI-generated temporally aligned lyric transcription 902 and/or the modified temporally aligned lyric transcription 1002 within the user interface frontend 100 in conjunction with a playback feature 908, which can assist users in determining the correct timestamps, words, and/or divisions for the modified lyric segments 1004A, 1004B (and others). The user interface frontend 100 can be configured to visually emphasize the lyric segment that temporally corresponds to the current playback timepoint of audio content being played pursuant to use of the playback feature 908.

As shown in FIG. 10, the division of lyric segments 904A from the AI-generated temporally aligned lyric transcription 902 into two modified lyric segments 1004A and 1004B in the modified temporally aligned lyric transcription 1002 each with their own timestamps 1006A and 1006B, respectively. The timestamp 1006B for the newly created modified lyric segment 1004B may be automatically estimated/determined, and may be refined by user input. In some implementations, the timestamp(s) for a newly created lyric segment within the lyric alignment interface 900 (e.g., resulting from the division of an AI-generated lyric segment) may be defined using one or more predefined rules. As one example, the timestamp for a newly created lyric segment within the lyric alignment interface 900 may be defined as the temporal midpoint between (i) the timestamp of the lyric segment divided to form the new lyric segment and (ii) the timestamp of the lyric segment that immediately follows the lyric segment divided to form the new lyric segment. As another example, the timestamp for a newly created lyric segment within the lyric alignment interface 900 may be defined based on the number of words or syllables in the lyric segment divided to form the new lyric segment and the number of words or syllables that result in each lyric segment after the division. Othe rules may be used. In some implementations, the timestamp(s) for a newly created lyric segment within the lyric alignment interface 900 may be defined using word-by-word timestamps determined via the alignment module 610 (as described above). For instance, the timestamp for the newly created lyric segment may correspond to the word timestamp of the first word of the newly created lyric segment.

In the example shown in FIG. 10, the lyric alignment interface 900 includes a control 1008 that is interactable by users to trigger definition of a finalized temporally aligned lyric transcription. When no modifications are made to the AI-generated temporally aligned lyric transcription 902, the AI-generated temporally aligned lyric transcription 902 may be defined as the finalized temporally aligned lyric transcription. When modifications are made to the AI-generated temporally aligned lyric transcription 902, the modified temporally aligned lyric transcription 1002 may be defined as the finalized temporally aligned lyric transcription. The finalized temporally aligned lyric transcription can include finalized timestamps associated with finalized lyric segments (and/or finalized words), which may be used to construct a lyric transcription package. The lyric transcription package may include the finalized temporally aligned lyric transcription, a language for the audio content 106, a track title, an artist name, and/or other information. A system may then submit the lyric transcription package to one or more distribution platforms (e.g., music distribution platforms).

Although the examples shown and described with reference to FIGS. 1-10 involve determining line-by-line timestamps for lyric segments of audio content, the disclosed principles may be implemented to determine word-by-word timestamps for the words of lyric segments of audio content. For instance, the alignment modules 610 and/or 708 may be used to generate word-by-word timestamps, which may be output and presented in conjunction with associated words on the user interface frontend 100 for user validation. The word-by-word timestamps may indicate the temporal beginning and/or end of each word within the duration of the underlying audio content. The word-by-word timestamps may be presented in conjunction with a playback feature of the user interface frontend 100, and, during playback of the audio content (or vocals stem), the word with timestamp(s) corresponding to the current playback time may be visually emphasized to assist users in validating and/or modifying the word-by-word timestamps.

In some embodiments, the user modifications to the various AI-generated outputs described herein (e.g., AI-generated lyric transcriptions, AI-generated temporally aligned lyric transcriptions) may be used as training data to further train and/or refine the AI models used to generate such outputs (e.g., the alignment modules 610 and/or 708).

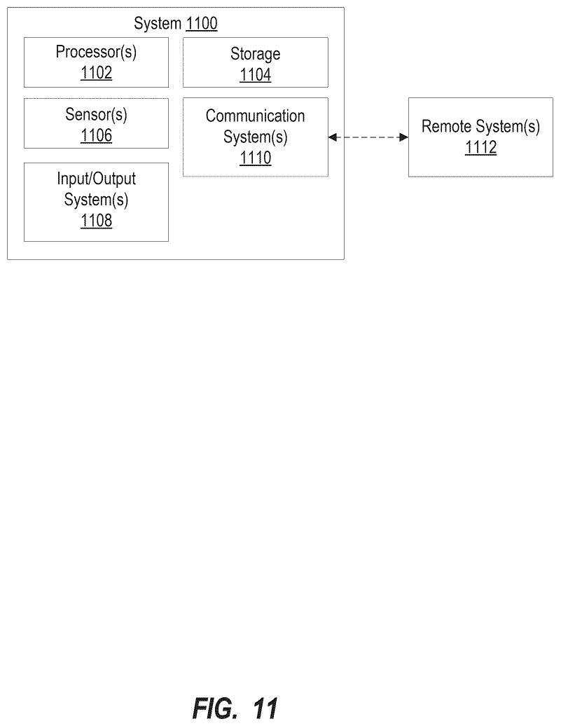

Disclosed embodiments include at least those represented in the following numbered clauses:
Clause 1. The subject matter shown and/or described herein.
Clause 2. A system for facilitating lyric acquisition: one or more processors; and one or more computer-readable recording media that store instructions that are executable by the one or more processors to configure the system to: receive first user input initiating or continuing a lyric acquisition workflow in association with audio content; after receiving the first user input, obtain an AI-generated lyric transcription, wherein the AI-generated lyric transcription comprises a plurality of lyric segments, each lyric segment of the plurality of lyric segments comprising a plurality of words; present a representation of the AI-generated lyric transcription in editable form; receive second user input associated with the representation of the AI-generated lyric transcription, wherein the second user input indicates a validated lyric transcription, wherein the validated lyric transcription comprises a plurality of validated lyric segments, each validated lyric segment comprising a plurality of validated words; after receiving the second user input that indicates the validated lyric transcription, obtain an AI-generated temporally aligned lyric transcription, wherein the AI-generated temporally aligned lyric transcription is generated based on the audio content and the validated lyric transcription, wherein the AI-generated temporally aligned lyric transcription comprises a respective timestamp associated with each validated lyric segment of the plurality of validated lyric segments; present a representation of the AI-generated temporally aligned lyric transcription in editable form; and receive third user input associated with the representation of the AI-generated temporally aligned lyric transcription, wherein the third user input indicates a finalized temporally aligned lyric transcription, wherein the finalized temporally aligned lyric transcription comprises a plurality of finalized lyric segments, each finalized lyric segment comprising a plurality of finalized words, and wherein the finalized temporally aligned lyric transcription comprises a respective finalized timestamp associated with each finalized lyric segment of the plurality of finalized lyric segments.
Clause 3. The system of any preceding or subsequent clause, wherein obtaining the AI-generated lyric transcription comprises (i) generating the AI-generated lyric transcription after receiving the first user input or (ii) accessing a previously generated AI-generated lyric transcription after receiving the first user input.
Clause 4. The system of any preceding or subsequent clause, wherein the AI-generated lyric transcription is generated by: utilizing the audio content as input to a stem separation module to obtain a vocals stem of the audio content; utilizing the vocals stem as input to a transcription module to obtain a set of lyrics; and utilizing the vocals stem and the set of lyrics as input to an alignment module to separate the set of lyrics into the plurality of lyric segments for the AI-generated lyric transcription.
Clause 5. The system of any preceding or subsequent clause, wherein the transcription module and/or the alignment module are configured to receive a language input.
Clause 6. The system of any preceding or subsequent clause, wherein the language input is obtained by (i) a user-defined language input or setting or (ii) utilizing the vocals stem as input to a language module to obtain the language input.
Clause 7. The system of any preceding or subsequent clause, wherein presenting the representation of the AI-generated lyric transcription in editable form includes presenting a playback feature configured for facilitating playback of the audio content or a vocals stem of the audio content.
Clause 8. The system of any preceding or subsequent clause, wherein the second user input associated with the representation of the AI-generated lyric transcription comprises one or more user inputs directed to: combining or separating one or more lyric segments of the plurality of lyric segments; modifying one or more words of one or more lyric segments of the plurality of lyric segments; and/or confirming the plurality of lyric segments to indicate the validated lyric transcription.
Clause 9. The system of any preceding or subsequent clause, wherein the AI-generated temporally aligned lyric transcription is generated by: utilizing the validated lyric transcription and a vocals stem from the audio content as input to an alignment module to obtain the respective timestamp associated with each validated lyric segment of the plurality of validated lyric segments.
Clause 10. The system of any preceding or subsequent clause, wherein the alignment module is configured to receive a language input.
Clause 11. The system of any preceding or subsequent clause, wherein the language input is obtained by (i) a user-defined language input or setting or (ii) utilizing the vocals stem as input to a language module to obtain the language input.
Clause 12. The system of any preceding or subsequent clause, wherein presenting the representation of the AI-generated temporally aligned lyric transcription in editable form includes presenting a playback feature configured for facilitating playback of the audio content or a vocals stem of the audio content.
Clause 13. The system of any preceding or subsequent clause, wherein, during playback of the audio content or the vocals stem, a corresponding validated lyric segment that temporally corresponds to a playback timepoint of the playback of the audio content or the vocals stem is visually emphasized.
Clause 14. The system of any preceding or subsequent clause, wherein the third user input associated with the representation of the AI-generated temporally aligned lyric transcription comprises one or more user inputs directed to: modifying the respective timestamp associated with one or more validated lyric segments of the plurality of validated lyric segments; and/or confirming the plurality of validated lyric segments and the respective timestamps to indicate the finalized temporally aligned lyric transcription.
Clause 15. The system of any preceding or subsequent clause, wherein the instructions are executable by the one or more processors to configure the system to: construct a lyric transcription package comprising: the finalized temporally aligned lyric transcription; a language associated with the finalized temporally aligned lyric transcription; a track title; and an artist name; and submit the lyric transcription package to one or more distribution platforms.
Clause 16. A system for facilitating lyric acquisition: one or more processors; and one or more computer-readable recording media that store instructions that are executable by the one or more processors to configure the system to: receive first user input initiating or continuing a lyric acquisition workflow in association with audio content; after receiving the first user input: obtain an AI-generated set of lyrics, and obtain an AI-generated temporally aligned lyric transcription, wherein the AI-generated temporally aligned lyric transcription is generated based on the audio content and the AI-generated set of lyrics, wherein the AI-generated temporally aligned lyric transcription comprises: a plurality of lyric segments, each lyric segment comprising a plurality of words; and a respective timestamp associated with each lyric segment of the plurality of lyric segments; present a representation of the AI-generated temporally aligned lyric transcription in editable form; and receive second user input associated with representation of the AI-generated temporally aligned lyric transcription, wherein the second user input indicates a finalized temporally aligned lyric transcription, wherein the finalized temporally aligned lyric transcription comprises a plurality of finalized lyric segments, each finalized lyric segment comprising a plurality of finalized words, and wherein the finalized temporally aligned lyric transcription comprises a respective finalized timestamp associated with each finalized lyric segment of the plurality of finalized lyric segments.
Clause 17. The system of any preceding or subsequent clause, wherein obtaining the AI-generated temporally aligned lyric transcription comprises (i) generating the AI-generated temporally aligned lyric transcription after receiving the first user input or (ii) accessing a previously generated AI-generated temporally aligned lyric transcription after receiving the first user input.
Clause 18. The system of any preceding or subsequent clause, wherein the AI-generated set of lyrics is generated by: utilizing the audio content as input to a stem separation module to obtain a vocals stem of the audio content; and utilizing the vocals stem as input to a transcription module to obtain the set of lyrics.
Clause 19. The system of any preceding or subsequent clause, wherein the AI-generated temporally aligned lyric transcription is generated by utilizing the vocals stem and the set of lyrics as input to an alignment module to separate the set of lyrics into the plurality of lyric segments for the AI-generated temporally aligned lyric transcription.
Clause 20. The system of any preceding or subsequent clause, wherein the transcription module and/or the alignment module are configured to receive a language input.
Clause 21. The system of any preceding or subsequent clause, wherein the language input is obtained by (i) a user-defined language input or setting or (ii) utilizing the vocals stem as input to a language module to obtain the language input.
Clause 22. The system of any preceding or subsequent clause, wherein presenting the representation of the AI-generated temporally aligned lyric transcription in editable form includes presenting a playback feature configured for facilitating playback of the audio content or a vocals stem of the audio content.
Clause 23. The system of any preceding or subsequent clause, wherein, during playback of the audio content or the vocals stem, a corresponding lyric segment that temporally corresponds to a playback timepoint of the playback of the audio content or the vocals stem is visually emphasized.
Clause 24. The system of any preceding or subsequent clause, wherein the second user input associated with the representation of the AI-generated temporally aligned lyric transcription comprises one or more user inputs directed to: combining or separating one or more lyric segments of the plurality of lyric segments; modifying one or more words of one or more lyric segments of the plurality of lyric segments; modifying the respective timestamp associated with one or more lyric segments of the plurality of lyric segments; and/or confirming the plurality of lyric segments and the respective timestamps to indicate the finalized temporally aligned lyric transcription.
Clause 25. The system of any preceding or subsequent clause, wherein the instructions are executable by the one or more processors to configure the system to: construct a lyric transcription package comprising: the finalized temporally aligned lyric transcription; a language associated with the finalized temporally aligned lyric transcription; a track title; and an artist name; and submit the lyric transcription package to one or more distribution platforms.
FIG. 11 illustrates example components of a system 1100 that may comprise or implement aspects of one or more disclosed embodiments. For example, FIG. 11 illustrates an implementation in which the system 1100 includes processor(s) 1102, storage 1104, sensor(s) 1106, I/O system(s) 1108, and communication system(s) 1110. Although FIG. 11 illustrates a system 1100 as including particular components, one will appreciate, in view of the present disclosure, that a system 1100 may comprise any number of additional or alternative components.

The processor(s) 1102 may comprise one or more sets of electronic circuitries that include any number of logic units, registers, and/or control units to facilitate the execution of computer-readable instructions (e.g., instructions that form a computer program). Processor(s) 1102 can take on various forms, such as CPUs, NPUs, GPUs, or other types of processing units. Such computer-readable instructions may be stored within storage 1104. The storage 1104 may comprise physical system memory and may be volatile, non-volatile, or some combination thereof. Furthermore, storage 1104 may comprise local storage, remote storage (e.g., accessible via communication system(s) 1110 or otherwise), or some combination thereof. Additional details related to processors (e.g., processor(s) 1102) and computer storage media (e.g., storage 1104) will be provided hereinafter.

In some implementations, the processor(s) 1102 may comprise or be configurable to execute any combination of software and/or hardware components that are operable to facilitate processing using machine learning models or other artificial intelligence-based structures/architectures. For example, processor(s) 1102 may comprise and/or utilize hardware components or computer-executable instructions operable to carry out function blocks and/or processing layers configured in the form of, by way of non-limiting example, single-layer neural networks, feed forward neural networks, radial basis function networks, deep feed-forward networks, recurrent neural networks, long-short term memory (LSTM) networks, gated recurrent units, autoencoder neural networks, variational autoencoders, denoising autoencoders, sparse autoencoders, Markov chains, Hopfield neural networks, Boltzmann machine networks, restricted Boltzmann machine networks, deep belief networks, deep convolutional networks (or convolutional neural networks), deconvolutional neural networks, deep convolutional inverse graphics networks, transformer networks, generative adversarial networks, liquid state machines, extreme learning machines, echo state networks, deep residual networks, Kohonen networks, support vector machines, neural Turing machines, combinations thereof (or combinations of components thereof), and/or others.

As will be described in more detail, the processor(s) 1102 may be configured to execute instructions stored within storage 1104 to perform certain actions. In some instances, the actions may rely at least in part on communication system(s) 1110 for receiving data from remote system(s) 1112, which may include, for example, separate systems or computing devices, sensors, servers, and/or others. The communications system(s) 1110 may comprise any combination of software or hardware components that are operable to facilitate communication between on-system components/devices and/or with off-system components/devices. For example, the communications system(s) 1110 may comprise ports, buses, or other physical connection apparatuses for communicating with other devices/components. Additionally, or alternatively, the communications system(s) 1110 may comprise systems/components operable to communicate wirelessly with external systems and/or devices through any suitable communication channel(s), such as, by way of non-limiting example, Bluetooth, ultra-wideband, WLAN, infrared communication, and/or others.

FIG. 11 illustrates that a system 1100 may comprise or be in communication with sensor(s) 1106. Sensor(s) 1106 may comprise any device for capturing or measuring data representative of perceivable phenomenon. By way of non-limiting example, the sensor(s) 1106 may comprise one or more image sensors, microphones, thermometers, barometers, magnetometers, accelerometers, gyroscopes, and/or others.

Furthermore, FIG. 11 illustrates that a system 1100 may comprise or be in communication with I/O system(s) 1108. I/O system(s) 1108 may include any type of input or output device such as, by way of non-limiting example, a display, a touch screen, a mouse, a keyboard, a controller, and/or others, without limitation.

Disclosed embodiments may comprise or utilize a special purpose or general-purpose computer including computer hardware, as discussed in greater detail below. Disclosed embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are one or more “physical computer storage media” or “computer-readable recording media” or “hardware storage device(s).” Computer-readable media that merely carry computer-executable instructions without storing the computer-executable instructions are “transmission media.” Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in hardware in the form of computer-executable instructions, data, or data structures and that can be accessed by a general-purpose or special-purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry program code in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Disclosed embodiments may comprise or utilize cloud computing. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Those skilled in the art will appreciate that at least some aspects of the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, wearable devices, and the like. The invention may also be practiced in distributed system environments where multiple computer systems (e.g., local and remote systems), which are linked through a network (either by hardwired data links, wireless data links, or by a combination of hardwired and wireless data links), perform tasks. In a distributed system environment, program modules may be located in local and/or remote memory storage devices.

Alternatively, or in addition, at least some of the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), central processing units (CPUs), graphics processing units (GPUs), and/or others.

As used herein, the terms “executable module,” “executable component,” “component,” “module,” or “engine” can refer to hardware processing units or to software objects, routines, or methods that may be executed on one or more computer systems. The different components, modules, engines, and services described herein may be implemented as objects or processors that execute on one or more computer systems (e.g., as separate threads).

One will also appreciate how any feature or operation disclosed herein may be combined with any one or combination of the other features and operations disclosed herein. Additionally, the content or feature in any one of the figures may be combined or used in connection with any content or feature used in any of the other figures. In this regard, the content disclosed in any one figure is not mutually exclusive and instead may be combinable with the content from any of the other figures.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is currently claimed is:

1. A system for facilitating lyric acquisition:
one or more processors; and
one or more computer-readable recording media that store instructions that are executable by the one or more processors to configure the system to:
receive first user input initiating or continuing a lyric acquisition workflow in association with audio content;
after receiving the first user input, obtain an AI-generated lyric transcription, wherein the AI-generated lyric transcription comprises a plurality of lyric segments, each lyric segment of the plurality of lyric segments comprising a plurality of words;
present a representation of the AI-generated lyric transcription in editable form;
receive second user input associated with the representation of the AI-generated lyric transcription, wherein the second user input indicates a validated lyric transcription, wherein the validated lyric transcription comprises a plurality of validated lyric segments, each validated lyric segment comprising a plurality of validated words;
after receiving the second user input that indicates the validated lyric transcription, obtain an AI-generated temporally aligned lyric transcription, wherein the AI-generated temporally aligned lyric transcription is generated based on the audio content and the validated lyric transcription, wherein the AI-generated temporally aligned lyric transcription comprises a respective timestamp associated with each validated lyric segment of the plurality of validated lyric segments;
present a representation of the AI-generated temporally aligned lyric transcription in editable form; and
receive third user input associated with the representation of the AI-generated temporally aligned lyric transcription, wherein the third user input indicates a finalized temporally aligned lyric transcription, wherein the finalized temporally aligned lyric transcription comprises a plurality of finalized lyric segments, each finalized lyric segment comprising a plurality of finalized words, and wherein the finalized temporally aligned lyric transcription comprises a respective finalized timestamp associated with each finalized lyric segment of the plurality of finalized lyric segments.

2. The system of claim 1, wherein obtaining the AI-generated lyric transcription comprises (i) generating the AI-generated lyric transcription after receiving the first user input or (ii) accessing a previously generated AI-generated lyric transcription after receiving the first user input.

3. The system of claim 1, wherein the AI-generated lyric transcription is generated by:
utilizing the audio content as input to a stem separation module to obtain a vocals stem of the audio content;
utilizing the vocals stem as input to a transcription module to obtain a set of lyrics; and
utilizing the vocals stem and the set of lyrics as input to an alignment module to separate the set of lyrics into the plurality of lyric segments for the AI-generated lyric transcription.

4. The system of claim 3, wherein the transcription module and/or the alignment module are configured to receive a language input.

5. The system of claim 4, wherein the language input is obtained by (i) a user-defined language input or setting or (ii) utilizing the vocals stem as input to a language module to obtain the language input.

6. The system of claim 1, wherein the second user input associated with the representation of the AI-generated lyric transcription comprises one or more user inputs directed to:
combining or separating one or more lyric segments of the plurality of lyric segments;
modifying one or more words of one or more lyric segments of the plurality of lyric segments; and/or
confirming the plurality of lyric segments to indicate the validated lyric transcription.

7. The system of claim 1, wherein the AI-generated temporally aligned lyric transcription is generated by:
utilizing the validated lyric transcription and a vocals stem from the audio content as input to an alignment module to obtain the respective timestamp associated with each validated lyric segment of the plurality of validated lyric segments.

8. The system of claim 7, wherein the alignment module is configured to receive a language input.

9. The system of claim 8, wherein the language input is obtained by (i) a user-defined language input or setting or (ii) utilizing the vocals stem as input to a language module to obtain the language input.

10. The system of claim 1, wherein the third user input associated with the representation of the AI-generated temporally aligned lyric transcription comprises one or more user inputs directed to:
modifying the respective timestamp associated with one or more validated lyric segments of the plurality of validated lyric segments; and/or
confirming the plurality of validated lyric segments and the respective timestamps to indicate the finalized temporally aligned lyric transcription.

11. The system of claim 1, wherein the instructions are executable by the one or more processors to configure the system to:
construct a lyric transcription package comprising:
the finalized temporally aligned lyric transcription;
a language associated with the finalized temporally aligned lyric transcription;
a track title; and
an artist name; and
submit the lyric transcription package to one or more distribution platforms.

12. A system for facilitating lyric acquisition:
one or more processors; and
one or more computer-readable recording media that store instructions that are executable by the one or more processors to configure the system to:
receive first user input initiating or continuing a lyric acquisition workflow in association with audio content;
after receiving the first user input:
obtain an AI-generated set of lyrics, and
obtain an AI-generated temporally aligned lyric transcription, wherein the AI-generated temporally aligned lyric transcription is generated based on the audio content and the AI-generated set of lyrics, wherein the AI-generated temporally aligned lyric transcription comprises:
a plurality of lyric segments, each lyric segment comprising a plurality of words; and
a respective timestamp associated with each lyric segment of the plurality of lyric segments;
present a representation of the AI-generated temporally aligned lyric transcription in editable form; and
receive second user input associated with representation of the AI-generated temporally aligned lyric transcription, wherein the second user input indicates a finalized temporally aligned lyric transcription, wherein the finalized temporally aligned lyric transcription comprises a plurality of finalized lyric segments, each finalized lyric segment comprising a plurality of finalized words, and wherein the finalized temporally aligned lyric transcription comprises a respective finalized timestamp associated with each finalized lyric segment of the plurality of finalized lyric segments.

13. The system of claim 12, wherein obtaining the AI-generated temporally aligned lyric transcription comprises (i) generating the AI-generated temporally aligned lyric transcription after receiving the first user input or (ii) accessing a previously generated AI-generated temporally aligned lyric transcription after receiving the first user input.

14. The system of claim 12, wherein the AI-generated set of lyrics is generated by:
utilizing the audio content as input to a stem separation module to obtain a vocals stem of the audio content; and
utilizing the vocals stem as input to a transcription module to obtain the set of lyrics.

15. The system of claim 14, wherein the AI-generated temporally aligned lyric transcription is generated by utilizing the vocals stem and the set of lyrics as input to an alignment module to separate the set of lyrics into the plurality of lyric segments for the AI-generated temporally aligned lyric transcription.

16. The system of claim 15, wherein the transcription module and/or the alignment module are configured to receive a language input.

17. The system of claim 16, wherein the language input is obtained by (i) a user-defined language input or setting or (ii) utilizing the vocals stem as input to a language module to obtain the language input.

18. The system of claim 12, wherein the second user input associated with the representation of the AI-generated temporally aligned lyric transcription comprises one or more user inputs directed to:
combining or separating one or more lyric segments of the plurality of lyric segments;
modifying one or more words of one or more lyric segments of the plurality of lyric segments;
modifying the respective timestamp associated with one or more lyric segments of the plurality of lyric segments; and/or
confirming the plurality of lyric segments and the respective timestamps to indicate the finalized temporally aligned lyric transcription.

19. The system of claim 12, wherein the instructions are executable by the one or more processors to configure the system to:
construct a lyric transcription package comprising:
the finalized temporally aligned lyric transcription;
a language associated with the finalized temporally aligned lyric transcription;
a track title; and
an artist name; and
submit the lyric transcription package to one or more distribution platforms.

20. A method for facilitating lyric acquisition:
receiving first user input initiating or continuing a lyric acquisition workflow in association with audio content;
after receiving the first user input, obtaining an AI-generated lyric transcription, wherein the AI-generated lyric transcription comprises a plurality of lyric segments, each lyric segment of the plurality of lyric segments comprising a plurality of words;
presenting a representation of the AI-generated lyric transcription in editable form;
receiving second user input associated with the representation of the AI-generated lyric transcription, wherein the second user input indicates a validated lyric transcription, wherein the validated lyric transcription comprises a plurality of validated lyric segments, each validated lyric segment comprising a plurality of validated words;
after receiving the second user input that indicates the validated lyric transcription, obtaining an AI-generated temporally aligned lyric transcription, wherein the AI-generated temporally aligned lyric transcription is generated based on the audio content and the validated lyric transcription, wherein the AI-generated temporally aligned lyric transcription comprises a respective timestamp associated with each validated lyric segment of the plurality of validated lyric segments;
presenting a representation of the AI-generated temporally aligned lyric transcription in editable form; and
receiving third user input associated with the representation of the AI-generated temporally aligned lyric transcription, wherein the third user input indicates a finalized temporally aligned lyric transcription, wherein the finalized temporally aligned lyric transcription comprises a plurality of finalized lyric segments, each finalized lyric segment comprising a plurality of finalized words, and wherein the finalized temporally aligned lyric transcription comprises a respective finalized timestamp associated with each finalized lyric segment of the plurality of finalized lyric segments.
